(19) United States
(12) Patent Application Publication
(10) Pub. No.: US 2011/0096775 A1
(43) Pub. Date: Apr. 28, 2011

(54) SYSTEM AND METHOD FOR MULTIPLEXING AND STREAMING CONTENTS

(75) Inventors: Eung Don Lee, Daejeon (KR); Sukhee Cho, Daejeon (KR); Jin Soo Choi, Daejeon (KR)

(73) Assignee: Electronic and Telecommunications Research Institute, Daejeon (KR)

(21) Appl. No.: 12/875,453

(22) Filed: Sep. 3, 2010

(30) Foreign Application Priority Data
Oct. 22, 2009 (KR) 10-2009-0100650
Nov. 9, 2009 (KR) 10-2009-0107384
Mar. 23, 2010 (KR) 10-2010-0025640

(51) Int. Cl. H04L 12/56

(52) U.S. Cl. 370/389

(57) ABSTRACT

Provided is a system and method for effectively multiplexing and streaming contents. The system may include a plurality of video packetized elementary stream (PES) packetizers to transform, to a video PES packet, elementary stream (ES) data encoded in a video encoder, a plurality of audio PES packetizers to transform, to an audio PES packet, ES data encoded in an audio encoder, a sync information generator to generate sync information for synchronizing each of decoded streams in a process of decoding a transport stream (TS) signal, and the TS packetizer to generate a plurality of program streams using the audio PES packet, the video PES packet, and the sync information, to generate program specific information (PSI) for a configuration of the plurality of program streams, and to insert the PSI between the plurality of program streams in a predetermined period to generate the TS signal.

### CROSS-REFERENCE TO RELATED APPLICATIONS

This application claims the priority benefit of Korean Patent Application Nos. 10-2009-0100650, filed on Oct. 22, 2009, 10-2009-0107384, filed on Nov. 9, 2009, and 10-2010-0025640, filed on Mar. 23, 2010, in the Korean Intellectual Property Office, the disclosures of which are incorporated herein by reference.

### BACKGROUND

1. Field

One or more embodiments relate to a system and method for multiplexing and streaming contents.

2. Description of the Related Art

Along with an increase in a number of broadcasting stations that may broadcast programs, a method of transmitting various programs as a single signal has recently received attention.

As for a conventional Moving Picture Experts Group-2 (MPEG-2) Transport Stream (TS) generated in accordance with the method of transmitting the various programs as the single signal, a length of a packet of the MPEG-2 TS may be designed to be identical to or shorter than a length of a packet used in an existing Asynchronous Transfer Mode (ATM) network, and thus may ensure compatibility between the MPEG-2 TS and the existing ATM network, and reduce a loss when a transmission error such as a packet loss occurs.

Specifically, all MPEG-2 TS packets may be configured with a length of 188 bytes regardless of a Packetized Elementary Stream (PES), and may have a header of 4 bytes.

However, based on a structure of the MPEG-2 TS, a video PES with a high capacity such as a ultra high definition (UHD) video may be divided into larger number of MPEG-2 TS packets in comparison with a Standard Definition (SD) video or a High Definition (HD) video, and thus an overhead with respect to the TS header of 4 bytes may be relatively increased.

Also, in a case of an audio PES with a low capacity, a larger number of MPEG-2 TS packets may be filled with stuff bytes in comparison with the video PES, and thus a possibility of occupying a relatively unnecessary bandwidth may be created.

In the MPEG-2 TS, each of the PESs may be identified by a Packet IDentifier (PID) of the TS header. Accordingly, the PID of 13 bits may need to be used for each 188 bytes, and thus an overhead in terms of the bandwidth and an overhead in terms of a processing where the PID may need to be filtered for each of the TS packets regardless of a program selected by a user. may occur.

Accordingly, there is a demand for reducing an unnecessary bandwidth and the overhead.

### SUMMARY

One or more embodiments provide a system and method for multiplexing and streaming contents, which may reduce a bandwidth, and an amount of a processing may be reduced.

According to an aspect of one or more embodiments, there may be provided a system for multiplexing and streaming contents, the system including: a plurality of video packetized elementary stream (PES) packetizers to transform, to a video PES packet, elementary stream (ES) data encoded in a video encoder; a plurality of audio PES packetizers to transform, to an audio PES packet, ES data encoded in an audio encoder; a sync information generator to generate sync information for synchronizing each of decoded streams in a process of decoding a transport stream (TS) signal, and to provide the generated sync information to the plurality of video PES packetizers, the plurality of audio PES packetizers, and a TS packetizer; and the TS packetizer to generate a plurality of program streams using the audio PES packet, the video PES packet, and the sync information, to generate program specific information (PSI) for a configuration of the plurality of program streams, and to insert the PSI between the plurality of program streams in a predetermined period to generate the TS signal.

The TS packetizer may divide the plurality of program streams into TS packets having predetermined lengths different from each other depending on an average transmission rate of a PES, and multiplex the plurality of program streams together in a standardized type within the TS packets.

The TS packetizer may insert a sync code configured of a predetermined byte before the PSI to generate the TS signal.

According to an aspect of one or more embodiments, there may be provided a method of multiplexing and streaming contents, the method including: generating a plurality of program streams using sync information for synchronizing each of decoded streams in a process of decoding an audio PES packet, a video PES packet, and a TS signal; generating PSI for a configuration of the plurality of program streams; and inserting the PSI between the plurality of program streams in a predetermined period, and generating the TS signal.

Additional aspects of embodiments will be set forth in part in the description which follows and, in part, will be apparent from the description, or may be learned by practice of the disclosure.

### EFFECT

According to an embodiment, the PSI may be divided using a fixed PSI period and a sync code with a specific pattern, and each of the PESs may be classified using information stored in the PSI, so that a Packet IDentifier (PID) of 13 bits may not need to be used for each TS packet. As a result, a band width (transmission rate/storage capacity) may be reduced, and an amount of a processing may be reduced

### BRIEF DESCRIPTION OF THE DRAWINGS

These and/or other aspects will become apparent and more readily appreciated from the following description of embodiments, taken in conjunction with the accompanying drawings of which:

FIG. 1 is a diagram illustrating a configuration of an example of a system for multiplexing/streaming contents according to an embodiment;

FIG. 2 is a diagram illustrating an example of a Transport Stream (TS) signal according to an embodiment;

FIG. 3 is a diagram illustrating an example of a program stream of FIG. 2;

FIG. 4 is a diagram illustrating another example of a program stream of FIG. 2; and

FIG. 5 is a flowchart illustrating a method of multiplexing and streaming contents according to an embodiment.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

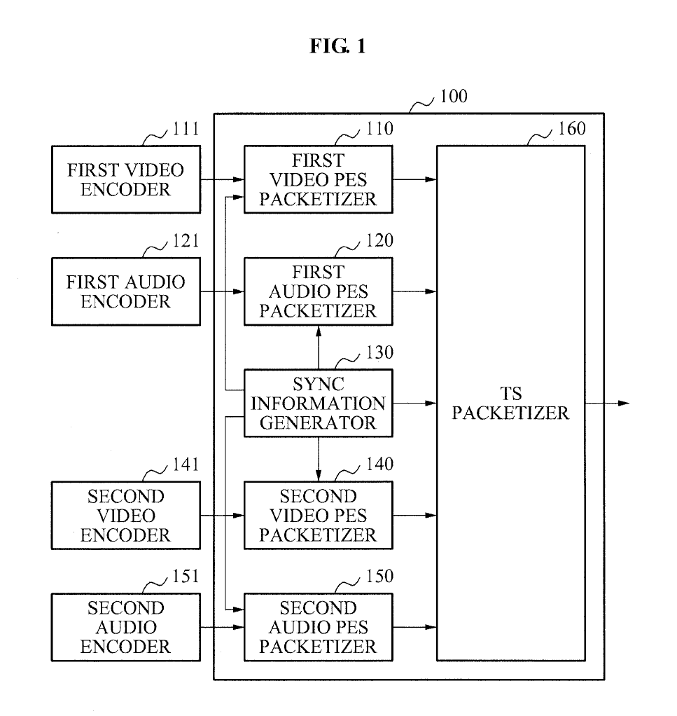

FIG. 1 is a diagram illustrating a configuration of an example of a system 100 for multiplexing/streaming contents according to an embodiment.

Referring to FIG. 1, the system 100 includes a first video packetized elementary stream (PES) packetizer 110, a first audio PES packetizer 120, a sync information generator 130, a second video PES packetizer 140, a second audio PES packetizer 150, and a Transport Stream (TS) packetizer 160.

As an example, the system 100 may be an encoder for configuring a TS including a plurality of programs.

The first video PES packetizer 110 may be a PES packetizer to transform, to a video PES packet, video elementary stream (ES) data encoded in a first video encoder 111, and the first audio PES packetizer 120 may be a PES packetizer to transform, to an audio PES packet, audio ES data encoded in a first audio encoder 121.

The sync information generator 130 may generate sync information for synchronizing each of decoded streams in a process of decoding a TS signal, and provide the generated sync information to the first video PES packetizer 110, the first audio PES packetizer 120, the second video PES packetizer 140, the second audio PES packetizer 150, and the TS packetizer 160.

In this instance, the sync information generated by the sync information generator 130 may include an Elementary Stream Clock Reference (ESCR), a Decoding Time Stamp (DTS), a Presentation Time Stamp (PTS), and a Program Clock Reference (PCR).

Specifically, the sync information generator 130 may transmit the ESCR, the DTS, and the PTS to the first video PES packetizer 110, the first audio PES packetizer 120, the second video PES packetizer 140, and the second audio PES packetizer 150, and enable the transmitted ESCR, DTS, and PTS to be added to a PES packet header in a process of transforming a PES packet.

Also, the sync information generator 130 may transmit the PCR to the TS packetizer 160, and enable the transmitted PCR to be added to a TS packet header in a multiplexing process of generating the TS signal including a TS packet.

The second video PES packetizer 140 may transform, to a video PES packet, video ES data encoded in a second video encoder 141, and the second audio PES packetizer 150 may transform, to an audio PES packet, audio ES data encoded in a second audio encoder 151.

Specifically, the second video PES packetizer 140 and the second audio PES packetizer 150 may respectively correspond to the first video PES packetizer 110 and the first audio PES packetizer 120, and may respectively packetize one of a plurality of programs included in the TS signal.

The TS packetizer 160, for example, a TS multiplexer (MUX) may generate the TS signal using the audio PES packet and the video PES packet which are transmitted from the first video PES packetizer 110, the first audio PES packetizer 120, the second video PES packetizer 140, and the second audio PES packetizer 150, and using the sync information transmitted from the sync information generator 130.

Specifically, the TS packetizer 160 may generate a plurality of program streams using the audio PES packet, the video PES packet, and the sync information, generate Program Specific Information (PSI) about a configuration of the plurality of program streams, and generate the TS signal by inserting the PSI between the plurality of program streams in a predetermined period.

In this instance, the TS packetizer 160 may divide the plurality of program streams into TS packets having predetermined lengths different from each other depending on an average transmission rate of a PES, and multiplexe the plurality of program streams together in a standardized type within the TS packets.

In this instance, by dividing the plurality of program streams into the TS packets, the TS packetizer 160 may reduce an overhead occurring due to a TS header in a case of the PES with a large capacity, and reduce a waste of a bandwidth occurring due to byte stuffing in a case of the PES with a small capacity.

As an example, the TS packetizer 160 may divide a video PES with a large capacity into TS packets each having a relatively long length, and divide an audio PES with a small capacity into TS packets each having a relatively short length. In this instance, each length the TS packets may be determined based on an average transmission rate of a corresponding PES.

Also, the PSI inserted in the TS signal by the TS packetizer 160 in a predetermined period may include a Program Association Table (PAT) and at least one Program Map Table (PMT) including information in units of the plurality of program streams, and the TS packetizer 160 may further insert a sync code configured of a predetermined byte string, before the PSI.

A PSI period, that is, a predetermined period where the PSI is inserted, and the sync code inserted before the PSI may be used for synchronizing the PSI period and parsing the PSI when what?? arbitrarily accesses the TS signal according to an embodiment.

In this instance, the PAT may include a number of the plurality of program streams combined between the PSI and another PSI, an average transmission rate of each of the plurality of program streams; a packetized order in the plurality of program streams, a length of each TS packet included in the plurality of program streams, and a multiplexing period.

Also, the PMT may include a number of the PESs/data included in each of the plurality of program streams combined between the PSI and another PSI, an average transmission rate of each of the PESs/data, the length of the TS packet of each of the PESs/data; and a multiplexing period.

In this instance, a length of the PAT and a length of the PMT may be changeable.

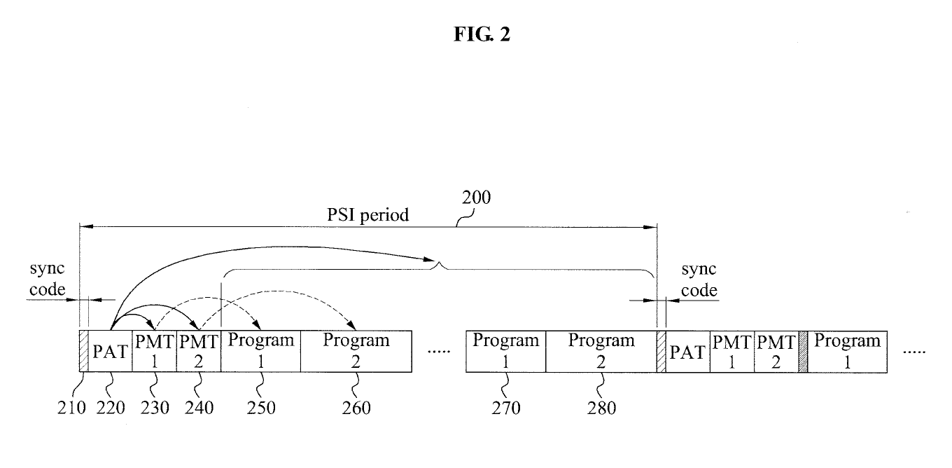

FIG. 2 is a diagram illustrating an example of a Transport Stream (TS) signal according to an embodiment.

As illustrated in FIG. 2, the TS signal according to an embodiment may include a single piece of the PSI for each PSI period 200, that is, a predetermined period where the PSI is inserted.

In this instance, the PSI may include at least one PMT 230 and 240 and a single PAT 220 in accordance with a type of a program included in the TS signal.

As an example, in FIG. 2, since a program 1 and a program 2 are included in the TS signal, a PMT (1) 230 and a PMT (2) 240 may be combined with a PAT 220 to configure the PSI.

In this instance, the PMT (1) 230 may include a number of PESs/data included in first program streams such as a program (1) 250 and a program (1) 270, an average transmission rate of each of the PESs/data, a packetized order, a length of a TS packet, and a multiplexing period.

Also, the PMT (2) 240 may include a number of PESs/data included in second program streams such as a program (2) 260 and a program (2) 280, an average transmission rate of each of the PESs/data, a packetized order, a length of a TS packet, and a multiplexing period.

A sync code 210 configured of a predetermined byte string may be combined before the PSI.

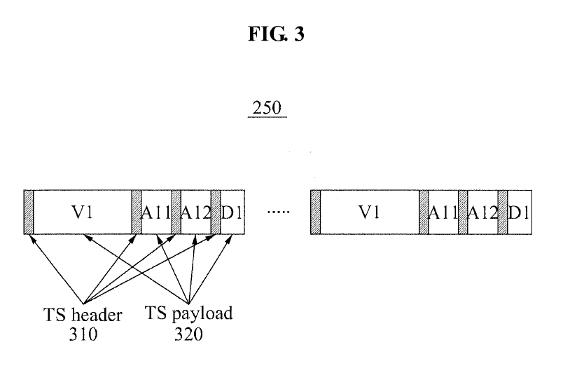

FIG. 3 is a diagram illustrating an example of a program stream of FIG. 2.

The program stream according to an embodiment may include a TS header 310 and a TS payload 320, as illustrated in FIG. 3.

In this instance, the TS header 310 may include information used for determining presence/absence of error bits and information about priority.

Also, the TS payload 320 may be a single video PES V1 including a video PES packet, an audio PES A11 or A12 including an audio PES packet, or a data stream D1 including subtitles or additional information.

As an example, the program (1) 250 of FIG. 2 may include the single video PES V1, the two audio PESs A11 and A12, and the single data stream D1.

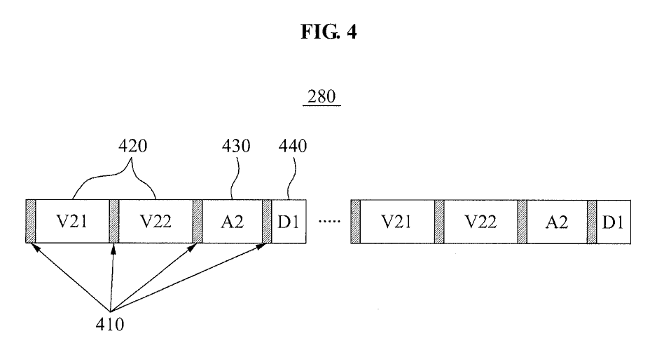

FIG. 4 is a diagram illustrating another example of a program stream of FIG. 1

Each stream included in the program stream according to an embodiment may be divided into TS packets having predetermined lengths different from each other depending on an average transmission rate of a PES, and may be classified by a TS header 410.

As an example, as illustrated in FIG. 4, a video PES 420 (V21 and V22) may have a different length from that of an audio PES 430 (A2) or that of a data stream 440 (D2).

Also, a program (2) 280 of FIG. 2 may include two video PESs V21 and V22, a single audio PES A2, and a single data stream D2.

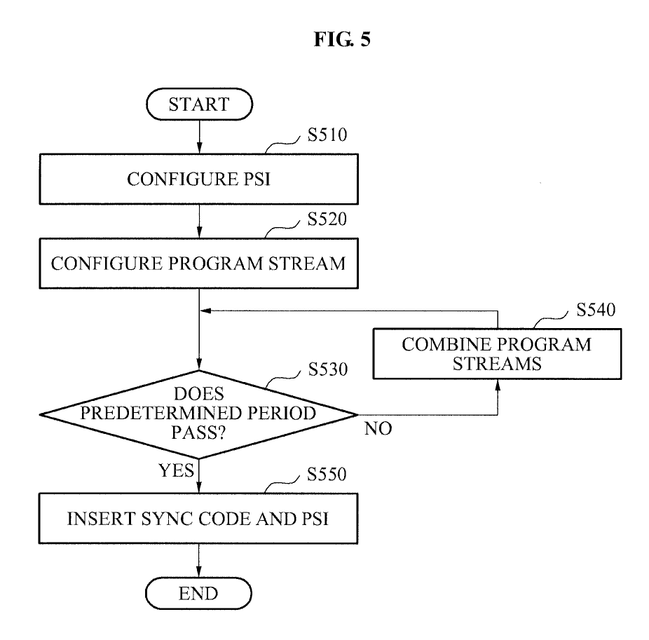

FIG. 5 is a flowchart illustrating a method of multiplexing and streaming contents according to an embodiment.

In operation S510, the TS packetizer 160 may generate a plurality of program streams using an audio PES packet, a video PES packet, and sync information.

Specifically, the TS packetizer 160 may generate the plurality of program streams for each program using the audio PES packet and the video PES packet transmitted from the first video PES packetizer 110, the first audio PES packetizer 120, the second video PES packetizer 140, and the second audio PES packetizer 150, and using the sync information transmitted from the sync information generator 130.

In operation S520, the TS packetizer 160 may generate a PSI, that is, information about a configuration of the program streams generated in operation S510.

In operation S530, the TS packetizer 160 may verify whether a predetermined period in time passes after inserting the PSI in the program stream generated in operation S520.

In this instance, the TS packetizer 160 may determine that the predetermined period passes in a case of the program stream where the PSI is not ever inserted.

In operation S540, the TS packetizer 160 may combine the plurality of program streams generated in operation S510.

In operation S550, the TS packetizer 160 may insert a sync code and the PSI generated in operation S520.

Specifically, the sync code and the PSI generated in operation S520 may be inserted in an initial part of a TS signal or a point when a predetermined period in time passes starting from the initial part. In this instance, the plurality of program streams combined in operation S540 may be positioned between the inserted PSIs.

Also, the TS packetizer 160 may perform operation S530 when the TS signal is not generated.

According to an embodiment, the PSI may be divided using a fixed PSI period being relatively longer than a conventional Moving Picture Experts Group (MPEG)-2 TS packet period (188 bytes) and using a sync code with a specific pattern, and each of the PESs may be classified using multiplexing and streaming shape information for the program streams described in the PAT and the PMT and using multiplexing and streaming shape information for the PES within each of the program streams.

Accordingly, since a Packet IDentifier (PID) of 13 bits is not need to be used for each TS packet, a band width (transmission rate/storage capacity) may be reduced, and an amount of a processing may be reduced due to elimination of a PID filtering.

The methods according to the above-described embodiments may be recorded in computer-readable non-transitory storage media including program instructions to implement various operations embodied by a computer. The media may also include, alone or in combination with the program instructions, data files, data structures, and the like. Examples of computer-readable non-transitory media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although a few embodiments have been shown and described, it would be appreciated by those skilled in the art that changes may be made in these embodiments without departing from the principles and spirit of the disclosure, the scope of which is defined by the claims and their equivalent.

What is claimed is:

1. A system for multiplexing and streaming contents, the system comprising:
a plurality of video packetized elementary stream (PES) packetizers to transform, to a video PES packet, elementary stream (ES) data encoded in a video encoder;
a plurality of audio PES packetizers to transform, to an audio PES packet, ES data encoded in an audio encoder;
a sync information generator to generate sync information for synchronizing each of decoded streams in a process of decoding a transport stream (TS) signal, and to provide the generated sync information to the plurality of video PES packetizers, the plurality of audio PES packetizers, and a TS packetizer; and
the TS packetizer to generate a plurality of program streams using the audio PES packet, the video PES packet, and the sync information, to generate program specific information (PSI) for a configuration of the plurality of program streams, and to insert the PSI between the plurality of program streams in a predetermined period to generate the TS signal.

2. The system of claim 1, wherein the TS packetizer divides the plurality of program streams into TS packets having predetermined lengths different from each other depending on an average transmission rate of a PES, and multiplexes the plurality of program streams together in a standardized type within the TS packets.

3. The system of claim 2, wherein the TS packetizer divides the video PES packet into the TS packet, the TS packet having a length longer than that of the audio PES packet.

4. The system of claim 2, wherein the PSI comprises:
a program association table (PAT) including information in units of the plurality of program streams; and
at least one program map table (PMT) including information in units of the PES for each program,
wherein the TS packetizer inserts, before the PSI, a sync code configured of a predetermined byte string to generate the TS signal.

5. The system of claim 4, wherein the PAT comprises at least one of:
a number of the plurality of program streams combined between the PSI and another PSI;
an average transmission rate of each of the plurality of program streams;
a packetized order in the plurality of program streams;
a length of each TS packet included in the plurality of program streams; and
a multiplexing period.

6. The system of claim 4, wherein the PMT comprises at least one of:
a number of the PESs/data included in each of the plurality of program streams combined between the PSI and another PSI;
an average transmission rate of each of the PESs/data;
a packetized order in the TS signals of each of the PESs/data;
a length of the TS packet of each of the PESs/data; and
a multiplexing period.

7. The system of claim 4, wherein a length of the PAT and a length of the PMT may be changeable.

8. A method of multiplexing and streaming contents, the method comprising:
generating a plurality of program streams using sync information for synchronizing each of decoded streams in a process of decoding an audio PES packet, a video PES packet, and a TS signal;
generating PSI for a configuration of the plurality of program streams; and
inserting the PSI between the plurality of program streams in a predetermined period, and generating the TS signal.

9. The method of claim 8, wherein the generating of the plurality of program streams comprises:
dividing the plurality of program streams into TS packets having predetermined lengths different from each other depending on an average transmission rate of a PES; and
multiplexing the plurality of program streams together in a standardized type within the TS packets.

10. The method of claim 9, wherein the dividing of the plurality of program streams into the TS packets divides the video PES packet into the TS packet having a length longer than that of the audio PES packet.

11. The method of claim 9, wherein the PSI comprises:
a PAT including information in units of the plurality of program streams; and
at least one PMT including information in units of the PES for each program,
wherein the generating of the TS signal inserts a sync code configured of a predetermined byte string, before the PSI to generate the TS signal.

12. The method of claim 11, wherein the PAT comprises at least one of:
a number of the plurality of program streams combined between the PSI and another PSI;
an average transmission rate of each of the plurality of program streams;
a packetized order in the plurality of program streams;
a length of each TS packet included in the plurality of program streams; and
a multiplexing period.

13. The method of claim 11, wherein the PMT comprises at least one of:
a number of the PESs/data included in each of the plurality of program streams combined between the PSI and another PSI;
an average transmission rate of each of the PESs/data;
a packetized order in the TS signals of each of the PESs/data;
a length of the TS packet of each of the PESs/data; and
a multiplexing period.

14. The method of claim 11, wherein a length of the PAT and a length of the PMT may be changeable.

15. A TS packetizer for generating a TS signal by combining an audio PES packet, a video PES packet, and sync information,
wherein the TS packetizer generates a plurality of program streams using the audio PES packet, the video PES packet, and the sync information, generates PSI for a configuration of the plurality of program streams, and inserts the PSI between the plurality of program streams in a predetermined period to generate the TS signal.
